(19) United States
(12) Patent Application Publication
(10) Pub. No.: US 2016/0259957 A1
(43) Pub. Date: Sep. 8, 2016

(54) System And Method For Monitoring And Protecting Healthcare Data

(71) Applicants: Kurt Knodt, Palo Alto, CA (US); Tomohito Shimizu, Cupertino, CA (US)

(72) Inventors: Kurt Knodt, Palo Alto, CA (US); Tomohito Shimizu, Cupertino, CA (US)

(73) Assignee: RICOH COMPANY, LTD., TOKYO (JP)

(21) Appl. No.: 14/640,275

(22) Filed: Mar. 6, 2015

(51) Int. Cl. G06K 7/10; G06K 19/02; G06F 19/00

(52) U.S. Cl. CPC G06K 7/10722; G06F 19/322; G06K 19/025

(57) ABSTRACT

An approach is provided for monitoring and protecting healthcare data. Documents that contain protected information are branded with a code. The code contains a human-readable component for easy identification and a computer-readable component for easy tracking. A tracking server may be configured to store information associated with the codes and update the information when the codes are scanned.

### FIELD OF THE DISCLOSURE

The present disclosure relates generally to labeling, managing, and tracking protected information.

### BACKGROUND

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

Healthcare information is becoming increasingly more difficult to manage in the modern age. Healthcare regulations, such as the Health Insurance Portability and Privacy Act (HIPAA), include standards for protection specific types of patient information. Protected Health Information (PHI) is a category of information about healthcare members that is protected under modern laws and regulations. While the regulations define certain types of protected information, it is not always clear to medical professionals and medical patients what types of information are protected. This lack of clarity may lead to information being misused, misplaced, or otherwise mishandled.

Generally, when a patient enters a doctor's office, the patient receives one or more forms to fill out before the patient may see the doctor. The forms generally do not indicate to the patient that information filled into the forms is protected. Likewise, healthcare professionals who receive the forms may not know that the forms contain protected information or which pieces of information are protected. If a healthcare professional does not determine that a form contains protected information, the form may be mishandled, possibly leading to misuse of the information and heavy fines for the healthcare professionals.

Based on the foregoing, there is a need for an approach for improving healthcare systems to make protected health information easily identifiable. There is a particular need for an approach for labeling forms, recordings, and other healthcare related records so they can be easily identified by a practitioner or a patient. In addition, there is a further need for a method of tracking healthcare related records that contain PHI to ensure that such documents are being protected in compliance with modern laws and regulations.

### SUMMARY

Techniques are provided for labeling documents that contain protected information and tracking the labeled documents. A computing device generates codes for documents containing protected information. The codes comprise a human-readable component to make the documents visually recognizable as containing protected information and a computer-readable component which may be read by a computing device.

Each code is stored in a database in relationship to a document and information about the document. A code reader is used to recognize the computer-readable component of the codes and communicate with a tracking server. When an action is taken with respect to a document, the database is updated to reflect that the action was taken.

Embodiments create and manage codes for digital documents. The computer-readable component for a digital document includes metadata which indicates to a tracking server that the document contains protected information. In some embodiments a multi-function peripheral contains a code generator for creating new codes and a printer for generating documents with the new codes. In other embodiments, a tracking service is utilized to create the codes and help a client track documents that contain the codes. Embodiments may be implemented by instructions processed by one or more processors, one or more computer-implemented methods, or devices or apparatuses configured accordingly.

### BRIEF DESCRIPTION OF THE DRAWINGS

In the figures of the accompanying drawings like reference numerals refer to similar elements.

FIG. 1 depicts an example form containing example an example PHI code.

FIG. 2 depicts an example embodiment of codes that may be placed on healthcare related documents.

FIG. 3 is a block diagram that depicts example network device configuration data.

FIG. 4 depicts an example embodiment of a system where a PHI code is generated in response to a user attempt to print a document.

FIG. 5 depicts an example embodiment where a PHI code is not attached to a document until the document contains PHI.

FIG. 6 depicts an example system infrastructure for tracking PHI codes.

FIG. 7 depicts an example graphical user interface for displaying PHI document information.

FIG. 8 is a block diagram depicting an example multi-function peripheral that creates and tracks PHI codes.

FIG. 9 is a block diagram of a computer system on which embodiments may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various embodiments are described hereinafter in the following sections:

I. OVERVIEW

II. PHI CODE GENERATION
A. PHI CODES
B. PHI DETERMINATION
C. FORM GENERATION

III. PHI CODE TRACKING

IV. TRACKING SERVICES

V. MULTI-FUNCTION PERIPHERAL

VI. IMPLEMENTATION MECHANISMS

### I. Overview

An approach is provided for managing and tracking documents containing certain types of information. While Protected Health Information (PHI) is discussed specifically, this is done for purposes of explanation only, and other types of information may be tracked along multiple documents using the techniques described herein. As described below, forms, documents, or other physical or digital media that contain or are designed to contain PHI are given a PHI code. The PHI code has a human-readable component to indicate to healthcare professionals and patients that the attached media may contain PHI. The PHI code also has a computer-readable component to allow a tracking system to monitor and track the attached media.

### II. PHI Code Generation

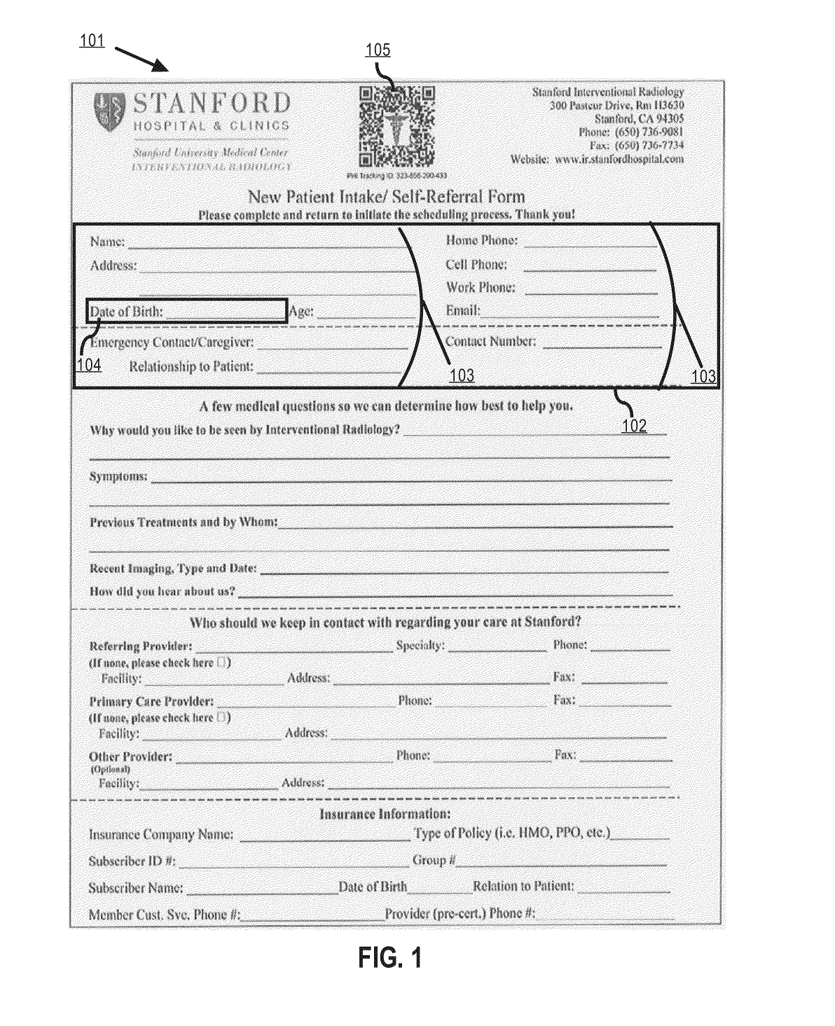

To help identify forms containing Protected Health Information (PHI) for healthcare professionals, tracking services, and patients, PHI codes may be attached to forms that contain or are designed to contain PHI. FIG. 1 depicts an example form 101 containing an example PHI code 105. PHI codes may be generated for forms that contain PHI, such as medical records, or forms that are designed to contain PHI, such as example form 101. Section 102 contains fields 103 that are designed to be filled out by a patient. Fields 103 do not contain PHI until a patient fills in the corresponding information. In some embodiments, PHI code 105 may be printed on any form designed to contain PHI. In other embodiments, PHI code 105 may be printed on a form only after PHI has been entered onto the form.

A. PHI Codes

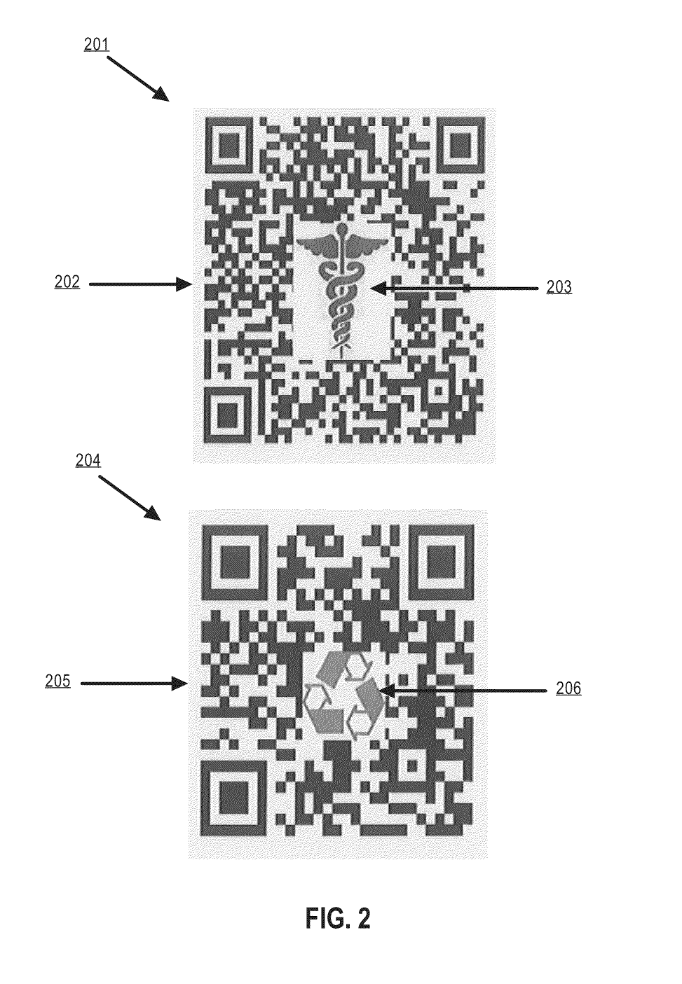

FIG. 2 depicts an example embodiment of codes that may be placed on healthcare related documents. Healthcare related documents may include any physical or electronic medium capable of visually conveying information. Thus, healthcare related documents may include forms, pictures, audio recordings, or video clips. PHI code 201 contains a computer-readable component 202 and a human-readable component 203. Computer-readable component 202 of PHI code 201 may be any symbol that can be recognized by a computer. In FIG. 2, computer-readable component 202 is depicted as a matrix barcode (also known as a Quick Response Code or QR Code), but various embodiments may include other forms of computer-readable codes, such as barcodes, infrared codes, magnetic ink characters, radio frequency identification tags, and near field communication signals. Human-readable component 203 may include a symbol that can visually indicate to a human that a document contains protected information. Any type of symbol may be used, depending upon a particular implementation, and embodiments are not limited to any particular symbol. For example, human-readable component 203 in FIG. 2 is a Caduceus which is commonly used as a symbol of healthcare organizations and medical practices. The human-readable component may be designed to be easily recognizable and to stand out on a document. For instance, the Caduceus symbol in FIG. 2 may be colored red in order for it to stand out on the document. As another example, for human-readable components that include text, the text may be displayed in a different font, size or using any special effect to make the human-readable component more visually conspicuous to a human.

In an embodiment, each generated PHI code is unique to a specific document and a specific iteration of the document. In other embodiments, the PHI codes are unique to a type of document or date of creation of a document. For example, one PHI code may be used to indicate that a set of documents were created on a specific day. As another example, one PHI code may be used for all patient admittance forms.

In some embodiments, a second symbol may be used to indicate that a document does not contain and/or is not designed to contain PHI. Non-PHI code 204 may also contain a computer-readable component 205 and a human-readable component 206. Non-PHI symbol 204 may be used to indicate that the document has been examined for PHI as opposed to a document with no symbol which may indicate that the document has yet to be examined and/or marked. Computer-readable component 205 of the non-PHI code 204 may indicate that a document does not contain PHI and thus does not need to be tracked. Alternatively, computer-readable component 205 of non-PHI code 204 may be uniquely generated for each document in order to track the documents for a different purpose. Human-readable component 206 of non-PHI code 204 may be designed to be easily recognizable and to indicate that a document does not contain PHI. For example, human-readable component 206 in FIG. 2 is the universal recycling symbol which is commonly used to designate recyclable materials. Human-readable component 206 of non-PHI code 204 may also be designed to be easily distinguishable from the human-readable component 203 of PHI code 201. For instance, if the Caduceus symbol in PHI code 201 is colored red, then the universal recycling symbol in non-PHI code 204 may be colored green or displayed with a different attribute or special effect.

PHI code 201 and non-PHI code 204 may be uniquely generated for each document and each copy of a document. Thus, different document types may have different PHI codes 201 and non-PHI codes 204 and each copy of a document type may have its own unique PHI code 201 or non-PHI code 204. For example, a business organization may choose to use different PHI codes and non-PHI codes for different types of PHI or classes of documents. As one non-limiting example, a first department of a medical facility may use a first PHI code, while a second department of the medical facility may use a second PHI code that is different than the first PHI code. The human-readable component, the computer-readable component, or both, may be different between the first PHI code and the second PHI code. For example, the first department of the medical facility may use a human-readable component that is visually unique to the first department of the medical facility so that a user viewing the document immediately recognizes both that the document contains PHI and is also associated with the first department of the medical facility. In addition, the human-readable component of the PHI code for the first department of the medical facility may include information that visually associates the document with a particular sub-department or sub-division of the first department of the first department of the medical facility. As one non-limiting example, the human-readable component of the PHI code for the first department of the medical facility may include an alphanumeric character, symbol or code associated with a particular sub-department or sub-division of the first department of the medical facility. In other embodiments, the human-readable component may remain unchanged across multiple copies of a document. In this situation, the computer-readable components of the documents may be associated with different document identifiers, allowing a system to track each document with a PHI code. Documents containing PHI codes may be tracked by a PHI tracking server or PHI tracking software using a PHI code database. When a change is made to a document, the PHI code database may be updated to indicate a change to the document.

In an alternative embodiment, a digital PHI code may be generated for digital documents, such as video recordings or digital files. In the case of digital documents, the human-readable component of the PHI code may be superimposed on the digital document. This may be done in a manner so as to not obscure the content of the digital document. For example, the human-readable component may be displayed as a watermark. As another example, in the case of a video or electronic medical record, the human-readable component of the PHI code may be displayed in a corner of the screen overlaying the video or in an adjacent window. In some embodiments, the human-readable component of the PHI code may be configured to only be displayed when a portion of the digital document containing PHI is displayed. For example, a video may display the PHI code whenever a patient or patient information appears on screen while a digital file may display the PHI code whenever a portion of the file on the screen is displaying PHI fields, “such as Date of Birth.” When a patient or patient information is not displayed, the PHI code may be un-displayed.

In an embodiment, the digital PHI codes may be displayed through an interface surrounding one or more web pages. For example, many electronic medical record systems involve displaying medical information through a web browser. A web based interface may be configured to display the human-readable component of a PHI code at times when the electronic medical records system is likely to be displaying PHI, such as during a patient lookup. The interface may be configured to remove the human-readable component of the PHI code at times when PHI is unlikely to be present, such as when the user logs in or out of the system.

The computer-readable component of a digital PHI code may include metadata inserted into the document. The metadata may indicate to a computer that a document is designated as containing or being designed to contain PHI. Additionally, the metadata may be associated with a unique document identification number which can be used to track the usage of the digital document. A user computing device may include an application which recognizes and responds to certain actions taken with respect to documents. For example, the application may recognize when a new document is created and begin the process of determining whether to attach a PHI code to the document. The application may also be configured to monitor user interactions with documents that contain a digital PHI code.

B. PHI Determination

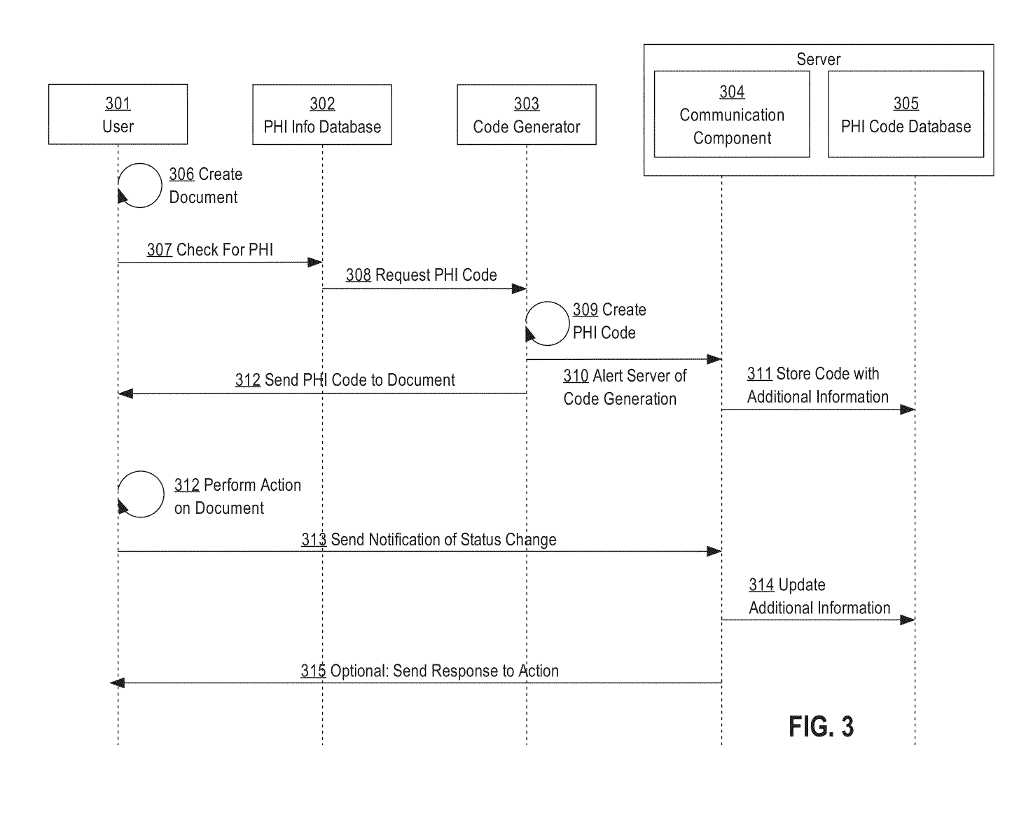

FIG. 3 depicts an example flow diagram that depicts an approach for labeling and tracking documents that contain or are designed to contain PHI. In an embodiment, user 301 interacts with PHI information database 302, code generator 303 and one or more server computers. User 301 may execute the interactions using one more computing devices. PHI information database 302 and code generator 303 may be implemented using one or more computer programs or other software elements that are loaded into and executed using one or more general-purpose computers, logic implemented in field programmable gate arrays (FPGAs) of application-specific integrated circuits (ASICs). In one embodiment, PHI information database 302 and code generator 303 execute on a computing device accessed by user 301. In another embodiment, PHI information database 302 and code generator 303 execute on one or more server computers. In an embodiment, one or more server computers include communication component 305 and PHI code database 305.

At step 306, a document is created or obtained by a user 301. In an embodiment, a user may specify whether a document contains or is designed to contain PHI upon creation of the document. Document creation may include, but is not limited to, opening a new document, printing an existing document, capturing a document, or storing a document under a new name. Alternatively, a user may specify information that may be used to determine if a document contains PHI. For example, a user may be provided with a list of categories or defining characteristics to be associated with a newly created document. One such characteristic may be described as “contains patient identifying information.” If the user selects that characteristic, the document may be flagged as containing PHI.

At step 307 a check is performed to determine if the document contains or is designed to contain PHI, as described in more detail hereinafter. For instance, PHI database 302 may be accessed to determine if a document contains or is designed to contain PHI. At a basic level, PHI database may include a list of documents that contain or are designed to contain PHI, such as new patient intake forms or patient information charts.

PHI database 302 may also contain other indicators that a document contains or is designed to contain PHI. In one such method, PHI database 302 may list a series of words or phrases commonly associated with PHI. For instance, example form 101 contains “Date of Birth” field 104. The phrase “Date of Birth” may be listed in the PHI database as being commonly associated with PHI. Thus, determining that a form contains or is designed to contain PHI may include the system identifying words or phrases in a form and matching them to words or phrases in the PHI database. Determining that a document contains PHI may also include determining the location in the document of PHI. In the above example, the “Date of Birth” field may be marked as a location of PHI within the document.

Similar methods may be used in the case of video or audio recordings. In the case of audio recordings, speech-to-text software may be implemented to convert the audio recordings into text documents. Once the audio recording has been converted into a text document, the words and phrases in the text document may be compared to words and phrases in the PHI database. In some embodiments, the speech-to-text software may also link the words or phrases in the text document to timestamps in the audio recording. This allows metadata to be inserted into the audio recording which indicates when PHI is being discussed. Alternatively, a user may indicate that an audio recording contains PHI when the audio recording is downloaded or saved to a computing device.

In the case of video recordings, more complicated software may be implemented to determine when PHI is being recorded. For instance, facial recognition software may be implemented to determine when a person aside from a healthcare practitioner is being displayed on-screen. Text-to-speech software may still be used to determine whether the audio portion of the video recording contains PHI. Alternative methods of analyzing a video may include object recognition software which determines whether forms, x-rays, or other patient related data is displayed on screen. As with the audio recordings, determining that a video recording contains

PHI may also include linking the discovered PHI to timestamps within the video recording. Alternatively, a user may indicate that a video recording contains PHI when the video recording is downloaded or saved to a computing device.

C. Form Generation

At step 308, a PHI code is requested for the document. While FIG. 3 depicts a request coming from PHI database 302, in other embodiments the request for a PHI code may originate from a user device or a PHI determination component. At step 309 code generator 303 may create a PHI code for the document. Each PHI code may be associated with a document identification number and document information. For example, a PHI code for a healthcare form may be associated with a unique identifier, the name and type of form, and the intended use of the form. Additional information may also be included such as the types of PHI in the form (addresses, social security numbers, etc.), an identification of a patient who used the form, an identification of the creator of the form, a method of creation of the form (e.g. printing, sorting, and copying), and a date and time of creation of the form.

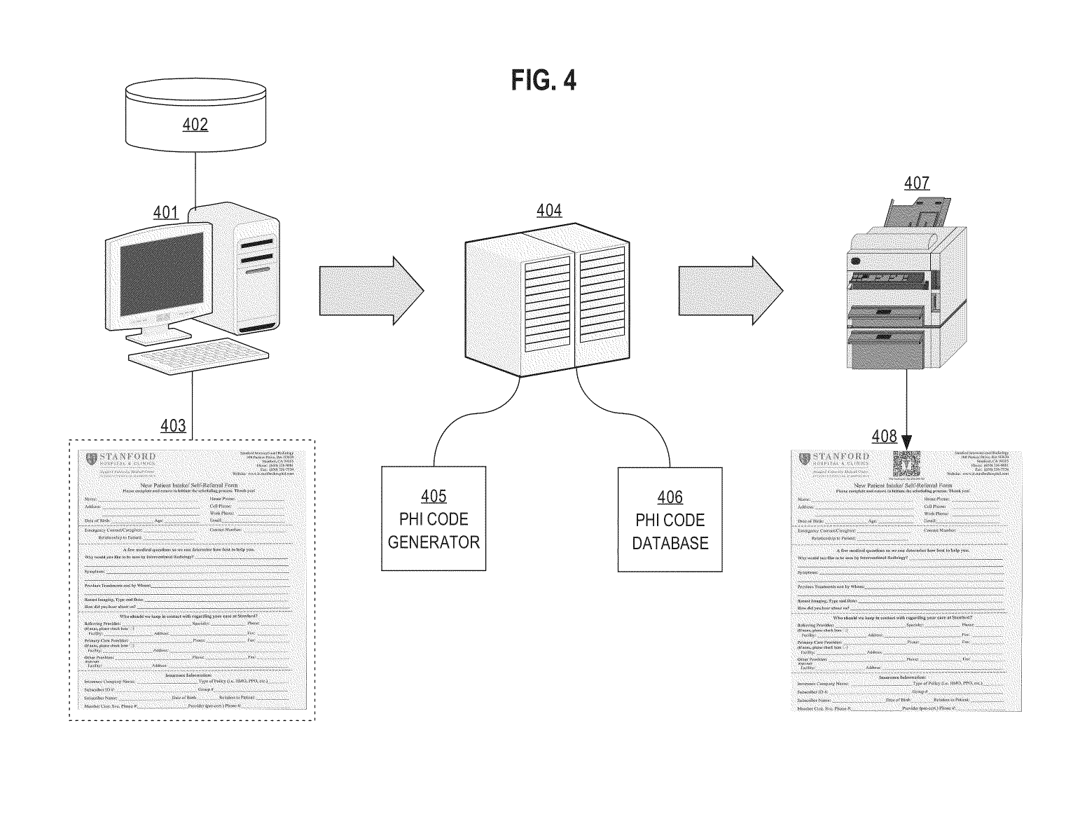

In an embodiment, steps 307, 308, and 309 may occur automatically, with or without the knowledge of the user, when a user chooses to print a document. FIG. 4 depicts an example embodiment of a system where a PHI code is generated in response to a user attempt to print a document. User device 401 contains internal storage 402. User device 401 may access healthcare form 403 from internal storage 402. When user device 401 attempts to print healthcare form 403, the request is intercepted by PHI server 404. PHI server 404 may contain PHI code generator 405 and PHI code database 406. When PHI code generator 405 creates a new PHI code, the PHI code is stored in PHI code database 406 along with any other identifying information such as document type, document identifier, or the action being taken with respect to the document. In the case of 406, for example, PHI code database 406 may store information that healthcare form 403 has been sent to printing device 407.

In alternative embodiments, steps 307, 308, and 309 take place either before or after healthcare form 403 is sent to printing device 407. In one such embodiment, software on user device 401 determines that a displayed form contains or is designed to contain PHI. The software on user device 401 may make this determination automatically or in response to receiving a request to save, print, copy, transmit, or delete healthcare form 403. In another such embodiment, printing device 407 may include software that searches for PHI indicators in a form before it prints the form. In either embodiment, once it is determined that a form contains or is designed to contain PHI, a message may be sent to PHI server 404 with a request to create a new PHI code and store the PHI code in PHI code database 406. Alternatively, PHI code generator 405 may exist on user device 401 or printing device 407. After PHI code generator 405 creates a new PHI code, a message may be sent to PHI server 404 indicating the creation of a new PHI code. The message may also include the action taken with respect to healthcare form 403 containing the new PHI code.

In some embodiments, PHI code generator 405 may determine where on healthcare form 403 to place the PHI code and may send healthcare form 403 to printing device 407 with the PHI code already added. In an embodiment, healthcare forms are pre-marked with the location of where a PHI code may be inserted. For example, when creating a new healthcare form, a healthcare professional may mark a blank space on the form that may be used for printing additional information, such as PHI codes, directly onto the form. While this space may appear blank, metadata associated with the form would include an indication that additional information may be printed in the blank space. Alternatively, certain forms may be associated in a database with certain locations on the form that are designated to contain PHI codes.

In another embodiment the PHI codes are printed in a standard location on a form. For example, the upper left hand location may be designated as the default position for printing PHI codes. If the form includes no metadata indicating where to print a PHI code and PHI server 404 does not recognize the form as one associated with a location to print the PHI code, then the default location may be used. In further embodiments, PHI code generator 405 looks for a blank spot on the form and prints the PHI code in the blank spot.

In alternative embodiments, printing device 407 may receive healthcare form 403 and the PHI code separately. Printing device 407 may then decide where to place the PHI code on healthcare form 403. In the embodiment shown in FIG. 4, printing device 407 creates PHI document 408 with the PHI code centered on the top of the document. In other embodiments, printing device 407 may have a different module for printing PHI codes. Printing device 407 may print the PHI code separately onto healthcare form 403 after health care form 403 has been printed. This also allows printing device 407 to print PHI codes on pre-existing physical documents or, alternatively, onto separate physical mediums to be attached to pre-existing physical documents. For example, printing device 407 may be configured to also print PHI codes onto stickers that may be attached to pre-existing physical documents.

Some forms may have PHI code placement information saved along with the form or separately with code generator 405. For example, healthcare form 403 may be a commonly used patient intake form. Information may be stored to indicate where PHI codes should be printed on this type of form.

In some embodiments, printing device 407 may be configured to attach radio-frequency identification (RFID) tags to some documents. Printing device 407 may be configured to directly print RFID tags onto documents to allow for easier tracking or to attach pre-existing RFID tags onto documents for easier tracking. In alternative embodiments, RFID tags may be attached to specific forms that present a higher risk of being removed from a healthcare facility.

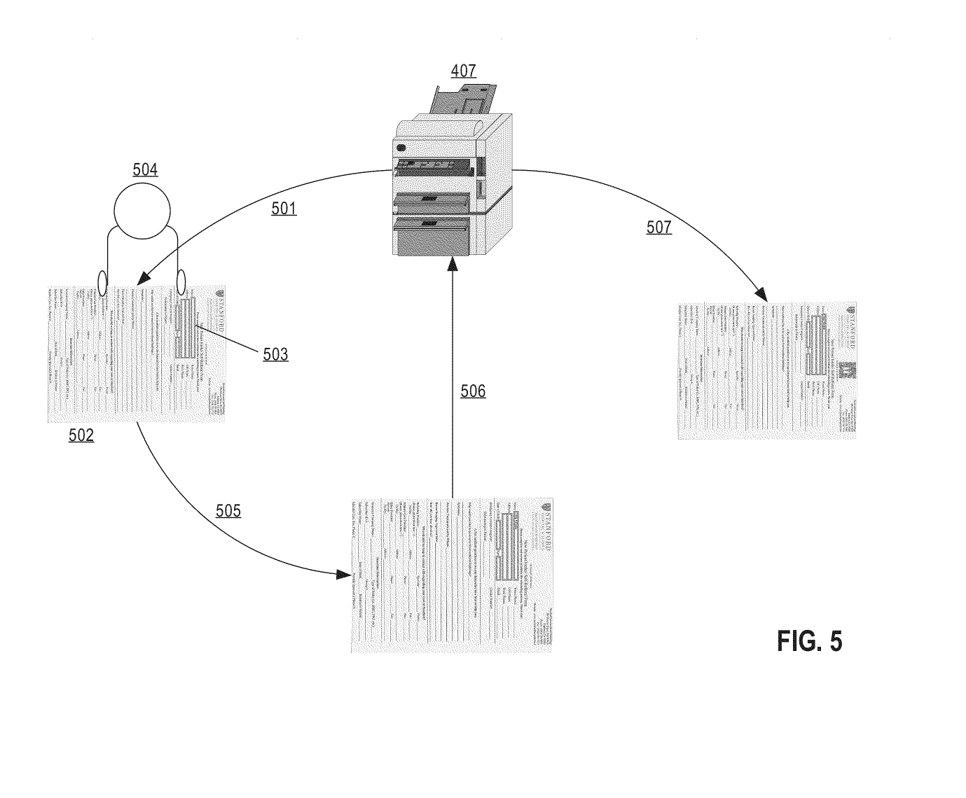

In alternative embodiments, printing device 407 may be configured to highlight fields on healthcare form 407 that are designed to contain PHI. Printing device 407 may mark these fields to make them easier to view for a user. Alternatively, printing device may mark the fields on healthcare form 407 in order to indicate to a capture device which fields on the form are designed to contain PHI. In some embodiments, a form may not be given a PHI code until certain fields are filled in by a user. For example, FIG. 5 depicts an example embodiment where a PHI code is not attached to a document until the document contains PHI. At step 501, printing device 407 prints highlighted healthcare form 502 with PHI fields 503 marked for readability by a computing device. At step 505, patient 504 enters information into one of PHI fields 503. At step 506, highlighted healthcare form 502 is fed back into printing device 407. Printing device 407 may then recognize that one of PHI fields 503 contains information. Alternatively, a computing device may be configured to recognize PHI fields on specific forms that are not highlighted and determine that data has been entered into those fields. At step 507, printing device may then generate a PHI code to be printed onto highlighted healthcare form 502. Completing step 507 may include, printing the PHI code directly onto highlighted healthcare form 502. Alternatively, completing step 507 may include capturing healthcare form 502, attaching the PHI code to a digital version of the document, printing a new version of the document with the PHI code attached, and destroying the original version of the document. While FIG. 5 depicts the same printing device printing the original form, capturing the edited form, and printing the PHI code, in alternative embodiments different devices may be used for each of these steps.

In some embodiments, a signal may be printed on a healthcare form to indicate that a document is designed to contain PHI. Creating this signal may range from placing a symbol on the face of the form to highlighting specific fields on the form that are designed to contain PHI. In contrast to FIG. 5, a form may be printed that includes both a PHI code and highlighted fields to indicate to a patient which fields of the document would be considered PHI when filled in by the patient.

When a document is printed that contains or is designed to contain PHI, additional educational information may also be printed which explains what PHI is and how PHI is protected. The additional educational information may be printed on the same form or on a separate page. The educational information allows a patient to not only see that a form is designed to contain PHI, but to also understand what PHI is and how it is protected. In some embodiments, the educational additional information is only printed automatically for forms that are designed to be seen or used by particular users. For example, a medical chart that is designed to be used by a medical professional may include a PHI code, but may not be printed along with the additional educational information. In contrast, a patient intake form is generally designed to be filled out by a patient. Thus, a patient intake form may include one or more of a PHI code, a signal indicating that the form is designed to contain PHI, markings on fields that are designed to contain PHI, and additional educational information describing PHI.

Another type of signal may be used to indicate that a form that does not contain PHI has been printed along with a form that does contain PHI. This may be useful for situations where PHI is being commingled with non-PHI. Instead of requiring healthcare practitioners to search through each document to determine if any of the documents contain PHI, a signal on any of the non-PHI containing forms may indicate to a practitioner that one of the forms associated with the non-PHI containing forms contains PHI. In alternative embodiments, the signal may be in the form of a notification sent to a user device or displayed on a printing device that indicates that a form containing PHI has been grouped with one or more forms that do not contain PHI.

The example depicted in FIG. 5 and described herein is done so in the context of physical documents, but embodiments are not limited to physical documents and similar features may be incorporated with respect to digital documents as well. For example, a digital document may contain fields that are marked as being designed to contain PHI. In some embodiments, these markings are visually apparent to the person accessing the document. Alternatively, the markings may include metadata of the document or indicators to a computing device that an action must be taken once data is entered into one or more field of a document or once a document is saved with information entered into one or more specific fields. Thus, if a user enters information into a field in a digital document that is designed to contain PHI, the PHI code generator may automatically generate a new PHI code and attach it to the digital document. Alternatively, when a document is saved the PHI code generator may search through the marked fields to determine if any information has been entered into them. If any of the marked fields contains information, the PHI code generator may create a new PHI code and attach it to the document. Although embodiments are depicted in the figure and described herein in the context of PHI server 404, PHI code generator 405 and PHI code database 406 being separate entities, this is done for purposes of explanation only and these elements may be combined in any combination and may be implemented at various locations including, for example, at user device 401 and printer 407.

### III. PHI Code Tracking

At step 310, code generator 303 sends an alert to communication component 304 of a server computing device that a new PHI code has been generated. This alert may occur before, after, or simultaneously with step 312 where code generator 303 sends the PHI code to the healthcare document. The alert may contain the additional information about the document described above. This information may be obtained through user input, extracting metadata from the document, and analyzing the document. As an example of analyzing the document, software may be configured to search a document for a field marked “name” or “patient name.” Data written into the field may be read by the software and added to the ‘patient name’ field of the additional information.

At step 311 the PHI code and the additional information may be stored in a PHI code database. The PHI code database may contain columns for additional pieces of information and rows associated with PHI codes. Alternatively, storing the PHI codes may instead comprise storing the document identifier associated with each code. Thus, the database may contain columns for additional information and rows associated with document identifiers. Translation from the PHI codes to document identifiers may occur at the user device or at the communication component of the server computer.

At step 313, a user performs an action with respect to the PHI document. These actions may include, but are not limited to, editing the document, editing the additional information about the document, printing the document, capturing the document in a digital format, transferring the document to another party either physically or digitally, creating a copy of the document, and destroying the document. In an embodiment, the user may use a computing device to read the computer-readable portion of the PHI code before performing the action on the document. Alternatively, a user may indicate that the user performed an action on a document by entering information into a computing device which identifies the document and the action performed on the document. For example, a healthcare practitioner may wish to create a copy of a patient intake form for a patient. The healthcare practitioner may place the patient intake form into a copier which scans the PHI code before creating a copy of the patient intake form with a new PHI code. The practitioner may then use a code reader to scan the new PHI code on the copy of the patient intake form and manually input information into a computing device that indicates that the copy is being given to a patient. Alternatively, the healthcare practitioner may manually search for the records associated with the copy of the patient intake form in the PHI code database. Once the healthcare practitioner has succeeded in finding the copy of the patient intake form on the computing device, the practitioner may manually input information that indicates that the copy is being given to a patient.

For digital documents, an application running on a computing device may be configured to recognize certain flagged actions. When a user executes one of these actions with respect to a document, the application may examine the metadata associated with the document to determine if the document contains a PHI code. If the document does not contain a PHI code, the application may make a determination as to whether a PHI code needs to be generated for the document. If the document does contain a PHI code, or if a PHI code is generated for the document, the application may decide to send a report to the communication component 304 of the server computer. For example, the application may be configured to track outgoing messages from a user computing device. If an outgoing message contains an attachment, the application may access the attachment to determine if it contains metadata associated with a PHI code.

At step 314 the action is reported to the communication component 304 of the server computer. The report may be generated by a computing device automatically or manually by the user. The report may indicate that the status of a document has been changed or that a violation has occurred with respect to the document. For example, in the case of destroying a document the report may indicate that the document has gone from ‘filed’ to ‘destroyed’. A violation report may include that a document was mishandled or displayed on a screen for too long. In some embodiments, copying a document creates a report that an original document has been copied and that two iterations of the same document exist. In other embodiments, creating a copy of a document is treated as creating a new document, causing a new PHI code to be generated. Additional information in the report may include an identification of the healthcare practitioner that performed the action and a timestamp for when the action was performed. At step 315, the server computer updates PHI code database 305 to indicate the change in status. Updating the additional information may involve changing a status field of the document or adding additional information into fields associated with the unique document identifier. For instance, updating the additional information in the above example of the destroyed document may include changing the status of the document from ‘filed’ to ‘destroyed’ and adding an event to an event log which describes what happened to the document, who performed the action, and when the action occurred.

In some embodiments, at step 316, certain actions may elicit a specific response from the server computer. Responses may range from sending notifications to blocking the action from occurring. For instance, additional information stored in the PHI code database may identify a specific document as locked. If a user attempts to electronically transmit the document, the PHI database may receive the report of the action and respond with a message to the application to block the user from transmitting the document. Other blocking responses may include stopping a user from downloading a document, creating a copy of a document, or accessing a document. These responses may also vary in response to the user attempting to perform the action. For instance, a healthcare professional may be granted permission to transmit a document where a healthcare employee may be barred from transmitting the document. Alert notifications may include displaying a message or warning to a user who is performing the action, a system administrator, or a monitoring party.

In some cases, a response from the server computer may involve instructions to make changes to the document, create an additional copy of the document, or alter the display of the user computing device. For instance, when a user opens a document that contains PHI, the application may send a message to the server indicating the document has been opened. The application may also track how long the document is being displayed on the user computing device. After a preset period of time has elapsed, the application may send a second notification to the server indicating that the document has been displayed for more than a pre-set period of time. Alternatively, a user may manually send a message to the server computer to indicate that a document containing PHI is being displayed. The server computer may respond with instructions to display a warning on the user computing device that PHI has been displayed on the user device for more than a preset period of time. Alternatively, the server computer may respond with instructions to alter the display of the user computing device (such as darkening the display), notify a third party about the extended display of PHI, or force the user computing device to close or minimize the document. In alternate embodiments, the application running on the user device may be configured to perform one or more actions without instruction from a server. For example, the application may be configured to darken the display of an idle computing device that is displaying PHI after a preset period of time.

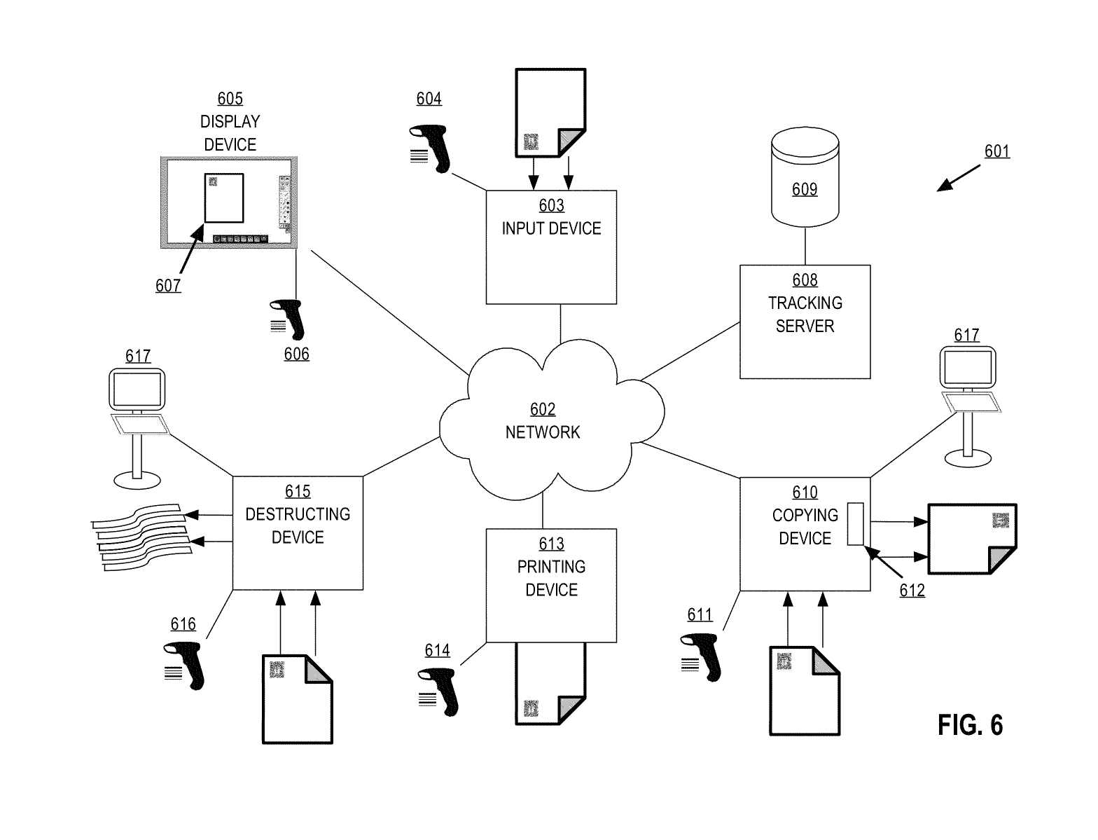

In an embodiment, multiple devices may be configured to detect PHI codes before performing an action on the document. FIG. 6 depicts an example system infrastructure for tracking PHI codes. System infrastructure 601 includes a network 602 and multiple devices connected to network 602. Network 602 may be implemented by any medium or mechanism that provides for the exchange of data between the various elements of FIG. 6. Examples of network 602 include, without limitation, one or more networks, such as one or more Local Area Networks (LANs), one or more Wide Area Networks (WANs), one or more Ethernets or the Internet, or one or more terrestrial, satellite or wireless links. The various elements of FIG. 6 may also have direct (wired or wireless) communications links, depending upon a particular implementation.

In an embodiment, devices connected to network 602 include input device 603, display device 605, tracking server 608, copying device 610, printing device 613, and destructing device 615. In alternative embodiments, one or more of input device 603, display device 605, tracking server 608, copying device 610, printing device 613, and destructing device 615 may be combined into fewer devices. For example, copying device 610 and printing device 613 may be combined into a multi-function peripheral. In other embodiments, system infrastructure 601 contains additional devices configured to interact with PHI codes.

In an embodiment, input device 603, display device 605, tracking server 608, copying device 610, printing device 613, and destructing device 615 contain a code reader. The code readers may have many forms, including but not limited to: a hand-held barcode reader, an RFID reader, a smartphone or tablet with a barcode reading App, a personal computer with software to manually enter PHI code characters, and a digital camera with a barcode reader. The code readers may exist as separate independent devices or as devices that have been integrated into the other devices in 601. The code readers are used to capture and initiate actions associated with a PHI labeled document along with additional information about the action.

A variety of user input mechanisms may be provided on the code readers. In its simplest form, the code readers have no input mechanisms other than reading a PHI code. More complex PHI readers could have buttons or keyboards for user input, to specify more information about what has happened to the PHI labeled document. The code readers may be attached to a device to associate PHI code reading with the function of that device. For example, when a PHI code is read by a code reader 616 attached to destructing device 615, this would signify that the document with that PHI code has been destroyed.

In an embodiment, input device 603 is used to create and manage documents with PHI codes. The Input device may be provided on a variety of hardware platforms including: a smartphone, tablet, laptop, or personal computer. The Input device can be a stand-alone device or may be integrated into other systems such as an EMR (Electronic Medical Records system) or Content Management system. Examples of functions the Input device is used to perform include but are not limited to: form generation, form storage, form editing, PHI code generation, or PHI event recording. Code reader 605 may be used to read a PHI code on a document that a user wants to edit. For example, a user may desire to update the additional information of a document to indicate that it is being given to a patient. The user may use code reader 605 to read the PHI code. Computing device 603 may then access a digital copy of the document, any records associated with the document, or both the digital copy of the document and the records associated with the document. The user may then make changes to the records to indicate that the document is being given to a patient. The changes may then be sent from computing device 603 to tracking server 608 across network 602.

In an embodiment, tracking server 608 contains local storage 609. Local storage 609 may contain a PHI code database which is used to track documents that contain or are designed to contain PHI from the moment of the document's inception to the moment of its destruction. Accessing records associated with a document may involve sending a request across network 602 to tracking server 608 for records associated with a scanned PHI code. Tracking server 608 may then access the information in local storage 609 and send the information through network 602 to the requesting device. Requested changes to information stored in local storage 609 may be sent by a computing device across network 602 to tracking server 608.

Display device 605 may be configured to display document 607. In an embodiment, document 607 represents PHI data with a PHI code shown in digital form. Display device 605 may also contain code reader 606. While code reader 606 is depicted as a physical device, in an embodiment code reader 606 may represent a digital code reader such as software executing on display device 605. When display device 605 initiates an action with respect to document 607, such as viewing document 607, code reader 606 may read the PHI code and send a message through network 602 to tracking server 608 to indicate that the action has taken place.

Copying device 610 may contain code reader 611 and code printer 612. When a document is placed into copying device 610, copying device 610 may read the PHI code and send a message through network 602 to tracking server 608 to indicate that a copy of the document is being made. Tracking server 608 may perform one or more of the following actions in response to receiving the indication from copying device 610: update the PHI code database to indicate that a copy is being made, send a message through network 602 to tracking server 608 to request a new PHI code for the copied document, and send instructions to copying device 610 to either block or allow printing of the copied document. In the case where a new PHI code is generated for the copy, copying device 610 may print the copy without the original PHI code on it. Code printer 612 may print the PHI code for the copy in the position of the original PHI code.

In an embodiment, copying device 610 creates a digital copy of the document and sends the digital copy through network 602 to one or more computing devices. In creating the digital copy, copying device reads the PHI code to identify the document. Copying device 610 then sends a message through network 602 to tracking server 608 requesting a new PHI code to be associated with a copy of the document. The message may include information associated with the original PHI code. Upon generating the code, tracking server 608 sends the new PHI code through network 602 to copying device 610. Copying device then sends a digital copy of the document along with a digital PHI code through network 602 to one or more computing devices. In alternative embodiments, the creation of the new PHI code may occur after the digital copy has been sent to the one or more computing devices. Copying device 610 may also be configured to remove the original PHI code from the document to eliminate confusion if the document is printed again later.

Printing device 613 may be configured to print a PHI code onto an existing document. Alternatively, printing device 613 may receive a document with the PHI code already attached. Printing device 613 may then print the document and the PHI code simultaneously. Printing device 613 may contain code reader 614. When printing device 613 prints a document, code reader 614 may read the PHI code on the document and send a message to tracking server 608 to indicate that the document was printed. Destructing device 615 may contain code reader 616. When a user places a document into destructing device 615, code reader 616 may read the PHI code and send a message to tracking server 608 to indicate that the document is being destroyed. Tracking server 608 may then update the data stored in local storage 609 to indicate that the document has been eliminated.

According to an embodiment, copying device 610 and destructing device 615 may be connected to user input modules 617. User input modules 617 may allow the system to identify the user performing the action or to accept changes to the additional information regarding the document. For instance, a user may input into the user input module 617 associated with copying device 610 that the copy is being given to a patient. Copying device 610 may send this information to tracking server 608. Tracking server 608 may then update local storage 609 to indicate that a specific user created a new iteration of the document and gave that iteration to the patient.

While FIG. 6 displays computing device 603, copying device 610, printing device 613, and destructing device 615 as standalone devices communicatively coupled to a single server over a network, in other embodiments one or more devices are operatively connected to a device server through a network. For example, printing device 613 may be connected a print server through which print jobs are routed. The print server may perform the PHI related functions such as PHI detection, code generation, and updating the PHI server. Similarly, copying device 610 may be connected to a scan server which receives the scanned images and performs the PHI related functions with respect to those images.

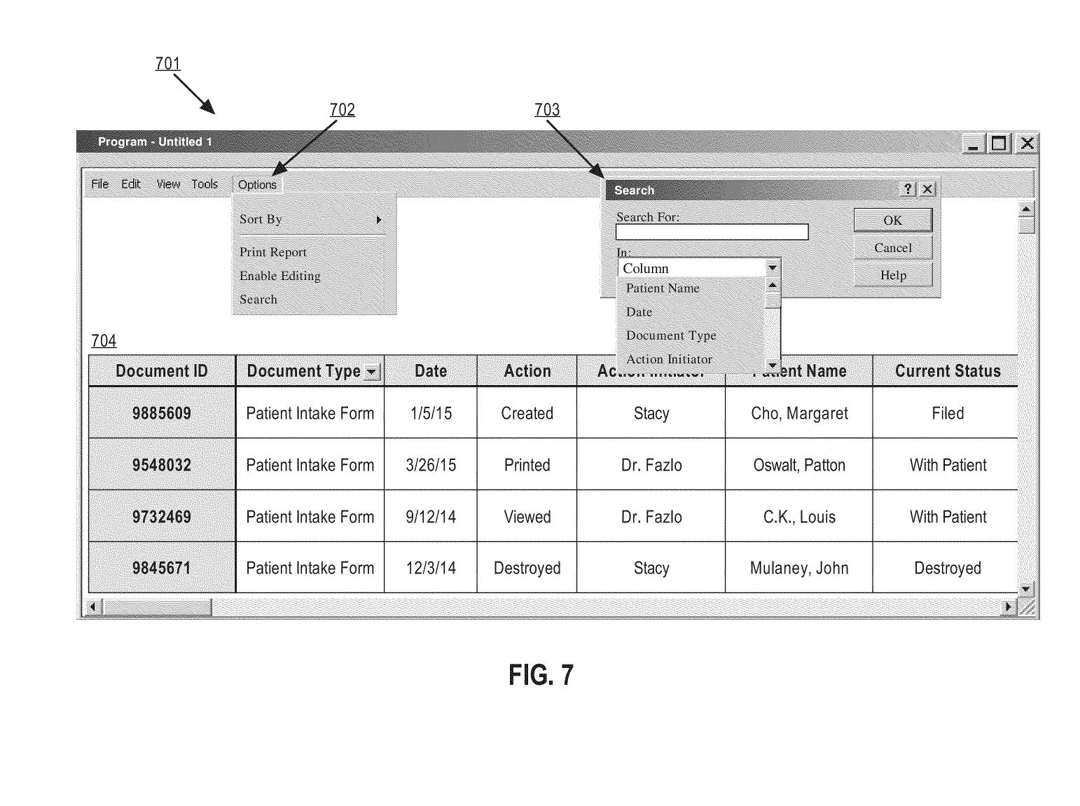

Data regarding tracked documents may be made available to a healthcare professional through a graphical user interface. FIG. 7 depicts an example graphical user interface 701 for displaying PHI document information. Graphical user interface 701 includes options menu 702, search feature 703 and document table 704. Search feature 702 includes drop down category menu 704 and editable text box 705. A user may execute a query against the PHI code database by selecting a column from drop down category menu 704 and typing in the requested information. For example, a user may select the “patient name” entry and search for “Oswalt” to find all records pertaining to patients with Oswalt in their name. This would allow a user to easily track down specific records.

Document table 704 may also be used to view multiple healthcare records. Using search feature 703, a user may narrow down the number of entries shown in document table 704. For example, a query of “patient intake form” under “Document Type” would return a table on populated with patient intake form. If a user prefers to search through the records manually, the sort option in options menu 702 allows the user to change the order in which documents are presented. Selecting a specific document from document table 704 may also present the user with additional information, such as all actions that have been performed on the document and a chain of custody of the document from its inception to the present time. Additionally, in the case of digital documents, PHI code database may also contain links to the location of the document for easier document retrieval.

### IV. Tracking Services

In an embodiment, a PHI tracking service may be provided for a healthcare customer. Various hardware devices such as code printers and code readers may be installed at a client location for use with the PHI tracking service. The PHI tracking service may also install software on the client devices which can communicate with a PHI server. The PHI tracking service may receive notifications from client devices and update databases to further track PHI documents.

The PHI tracking service may generate and maintain data that specifies actions performed with respect to PHI documents. For example, the PHI tracking service may maintain PHI tracking data that specifies when and where a PHI document was created, disseminated/copied, updated and/or destroyed. The PHI tracking service may maintain the PHI tracking data in a secure manner so that it may be used for regulatory compliance purposes. Additionally, the PHI tracking service may evaluate current healthcare regulations to determine if the client is within regulation standards. If the client is not following current healthcare regulations, the PHI tracking service may generate compliance reports and recommendations to help the client comply with the current healthcare regulations. The PHI tracking service may also offer a training program to instruct users how to recognize the PHI codes and understand the compliance guidelines for PHI.

In an embodiment, the PHI tracking service may also generate the PHI codes for physical and digital documents. With pre-existing documents, the PHI tracking service may attach new PHI codes to the documents and save information about the documents in the PHI code database. The PHI tracking service may also facilitate in document capture and document destruction. For example, locked boxes may be provided to customers for digitizing documents and destroying documents. Customers may place documents they want digitized or destroyed into one of these boxes. The PHI tracking service may then collect the boxes, perform the requested action on the documents, and update the PHI code database.

The PHI tracking service may also be responsible for generating reports for clients. Generating reports may include determining a level of compliance with current healthcare regulations and creating recommendations based on the level of compliance. Reports may also list documents that contain PHI but are unaccounted for. For example, a user may input into a computing device that a document is being removed from storage to receive edits. If no other input is received on the document before the report is generated, the document may be listed as “missing.” Missing documents may be featured in the reports along with the last known location, the last action taken on the document, and the last person who accessed the document. Additionally, reports may be generated to show that a client is in compliance with current regulation standards in the case of complaints or audits.

Reports may also include tracking information for training purposes. This information may include identification of employees and a level of compliance with current healthcare regulations. Individual reports and recommendations may be created for each employee to help the employees learn to manage documents that contain PHI.

In an embodiment, a client may contact the tracking service to help track down a missing report or respond to complaints related to PHI documents. For example, in the case where a patient complains that a form containing PHI was found outside a medical facility, the client may contact the PHI tracking service to request data regarding that form. The PHI tracking service may then generate a report showing how many iterations of the document were created and where those copies were disseminated. The PHI tracking service may also contact the client with notifications in response to one or more events. For example, if a document has been missing for a specified period of time, the PHI tracking service may send a notification to the client describing the document and requesting an update of its status. The PHI tracking service may also contact the client if a document containing an RFID tag has been removed from a building, a document has been displayed on a screen for longer than a specified period of time, or the client has fallen below a specified level of compliance with current healthcare regulations.

### V. Multi-Function Peripherals

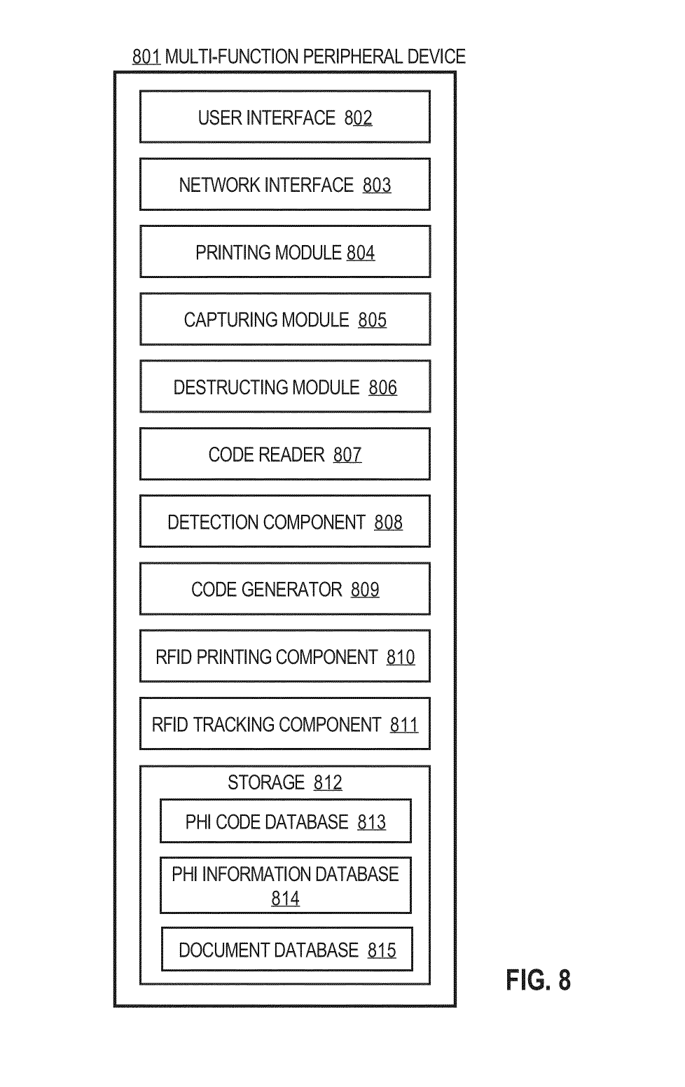

In an embodiment, two or more components of FIG. 3 and FIG. 6 may exist in the same multi-function peripheral (MFP). An MFP is a device that performs one or more functions, such as printing, copying, facsimile and document scanning. An example MFP is illustrated in FIG. 8. MFP 801 contains user interface 802 for accepting user input and displaying information and network interface 804 for communicating with other devices over a network. User interface 802 may be used to search for specific documents, display information relating to specific documents, display notifications or warnings when a document containing PHI is accessed, or input additional information to be stored with the PHI code of a document. Additionally, user interface 802 may contain an authorization system which identifies the person attempting to access or change a PHI containing document. The identification may later be used to establish a chain of custody for the printed document. Network interface 803 may be used to interact with other computing devices. In some embodiments, network interface 803 may also interact with a PHI server to indicate changes to documents containing PHI. The PHI server may also send notifications, warnings, or instructions through network interface 803 to MFP 801.

MFP 801 may also contain modules for creating, editing, copying, capturing, or destroying documents. Printing module 804 may be configured to print documents and PHI codes. PHI codes may be printed separately before or after printing the document. Alternatively, PHI codes may be printed simultaneously with the document in a designated position. Capturing module 805 may be configured to capture an image of a document for storage, printing, or PHI detection. In some embodiments, capturing module 805 may also detect the presence of and read a PHI code on a document. Alternatively, a separate code reader 807 may exist to read PHI codes before the document is accessed by the capture component. Destructing module 806 may be used to safely destroy documents.

Detection component 808 detects PHI in documents using any of the methods described above in Section II. B. Detection component 808 may be configured to search for PHI on documents that do not already contain a PHI code. Detection component 808 may be configured to detect PHI before a document is printed and after a document has been captured. If detection component 808 discovers PHI or if a user inputs into user interface 802 that a document contains PHI, code generator 809 may create a PHI code for the document. The PHI code may be stored in PHI code database 813 along with any additional information about the document. Additional information may include metadata extracted from actions taken on the document by MFP 801, information extracted from the document itself, analysis information created by MFP 801 of the document, information input by a user into user interface 802, and information received across network interface 803.

RFID printing component 810 may be configured to print or attach RFID tags to a physical document. RFID tracking component 811 may be configured to track the RFID tags and generate alerts when the RFID tags have been moved from a predetermined location. Additionally, RFID tracking component may be configured to respond to a request to find a specific document with an RFID tag. RFID tracking component may determine the location of the RFID tag and then send the location to user interface 802 or through network interface 803 to a user computing device.

In an embodiment, MFP 801 contains storage 812. Storage 812 may contain PHI code database 813 for storing and tracking PHI codes, PHI database 814 for determining if a document contains PHI, and document database 815 for determining if a type of document contains PHI. In addition, document database may include images of documents associated with PHI codes to be compared to scanned documents or to be printed for general use. For example, document database may contain an image of a patient intake form. When a patient intake form is captured, it may be compared to documents in document database 815. MFP 801 may determine that the form is a patient intake form and update the document with a PHI code or a marking of fields designed to contain PHI. Additionally, a blank patient intake form may be printed from document database 815.

In alternative embodiments, MFP 801 may contain less than all of the described components. For example, PHI tracking may occur at a server computer which communicates with network interface 803. Thus, PHI code database 813, PHI database 814, and document database 815 may exist on a server computer separate from MFP 801.

Multiple modules of MFP 801 may work together to accomplish more complex tasks. For example, a user may input a request into user interface 802 to add a PHI code to a document. After the document is fed into MFP 801, capture module may create a digital image of the document. After the digital image is created, MFP 801 may search the digital image for an empty space on the document to place the PHI code. Alternatively, MFP 801 may compare the captured image to documents stored in document database 815 to determine if a similar document exists. If MFP 801 finds a similar document, MFP 801 may then choose to place the PHI code in the same location as it is placed on the similar document. The process of determining where to place the PHI code may also be influenced by the user. For example, the user may enter a document type into user interface 802. The document type may be associated with a location for placing a PHI code. Alternatively, user interface 802 may display the captured image of the document. The user may then manually input into user interface 802 the desired location for the PHI code. Printing component 804 may then print the PHI code in the determined location on the document based on the captured image of the document.

In another example, a user may input into user interface 802 a request to digitize one or more documents. After the documents are fed into MFP 801, code reader 807 may scan each document's PHI code. Capture module 805 may then capture an image of each document. MFP 801 may attach metadata to the captured image of each document based at least in part on the scanned PHI code before either storing the digital document in storage 812 or sending the digital document to a different device using network interface 803. After an image of the document has been captured, the document may be sent to destructing module 806 to be destroyed. In an embodiment, a user may be presented with the captured image of each document on user interface 802 before the document is sent to destructing module 806. User interface 803 may prompt the user to either accept the captured image and destroy the document, or reject the captured image and return the document. Using this method, systems with large amounts of physical files may safely digitize the files while ensuring protection of the PHI.

In an alternative embodiment to the above example, documents that do not contain PHI may still be captured by capturing module 805. In one embodiment, user interface 802 may prompt the user to input whether each document contains PHI and any other information the user wants associated with the document, such as document type or patient name. In other embodiments, detection component 808 may determine whether each scanned document contains PHI using any of the methods described above in Section II. B. If PHI is discovered by detection component 808, then code generator 809 may create a new PHI code for the document and insert metadata into the captured image of the document before the document is stored in storage 812 or sent to a different device using network interface 803. User interface 802 may also display documents which were not determined to contain PHI to a user. The user may make a determination with regards to whether these documents contain PHI and update the document information on user interface 802 accordingly. After an image of the document has been captured, the document may be sent to destructing module 806 to be destroyed. Using this method, large numbers of documents may be digitized and associated with PHI codes for easier storage and tracking.

### VI. Implementation Mechanisms

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

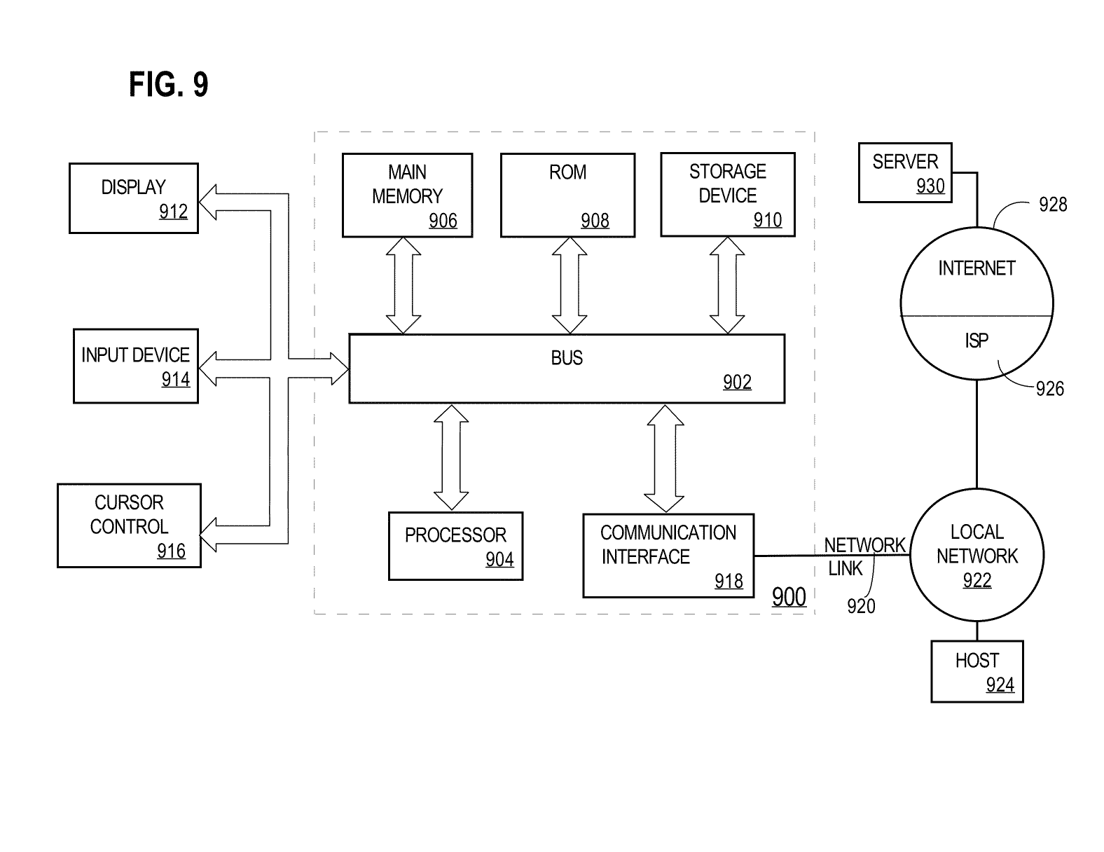

FIG. 9 is a block diagram that depicts an example computer system 900 upon which embodiments may be implemented. Computer system 900 includes a bus 902 or other communication mechanism for communicating information, and a processor 904 coupled with bus 902 for processing information. Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Computer system 900 further includes a read only memory (ROM) 908 or other static storage device coupled to bus 902 for storing static information and instructions for processor 904. A storage device 910, such as a magnetic disk or optical disk, is provided and coupled to bus 902 for storing information and instructions.

Computer system 900 may be coupled via bus 902 to a display 912, such as a cathode ray tube (CRT), for displaying information to a computer user. Although bus 902 is illustrated as a single bus, bus 902 may comprise one or more buses. For example, bus 902 may include without limitation a control bus by which processor 904 controls other devices within computer system 900, an address bus by which processor 904 specifies memory locations of instructions for execution, or any other type of bus for transferring data or signals between components of computer system 900.

An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

Computer system 900 may implement the techniques described herein using customized hard-wired logic, one or more ASICs or FPGAs, firmware and/or program logic or computer software which, in combination with the computer system, causes or programs computer system 900 to be a special-purpose machine. According to one embodiment, those techniques are performed by computer system 900 in response to processor 904 executing one or more sequences of one or more instructions contained in main memory 906. Such instructions may be read into main memory 906 from another computer-readable medium, such as storage device 910. Execution of the sequences of instructions contained in main memory 906 causes processor 904 to perform the process steps described herein. In alternative embodiments, hard-wired circuitry may be used in place of or in combination with software instructions to implement the invention. Thus, embodiments are not limited to any specific combination of hardware circuitry and software.

The term “computer-readable medium” as used herein refers to any medium that participates in providing data that causes a computer to operate in a specific manner. In an embodiment implemented using computer system 900, various computer-readable media are involved, for example, in providing instructions to processor 904 for execution. Such a medium may take many forms, including but not limited to, non-volatile media and volatile media. Non-volatile media includes, for example, optical or magnetic disks, such as storage device 910. Volatile media includes dynamic memory, such as main memory 906. Common forms of computer-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or memory cartridge, or any other medium from which a computer can read.

Various forms of computer-readable media may be involved in carrying one or more sequences of one or more instructions to processor 904 for execution. For example, the instructions may initially be carried on a magnetic disk of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918. The received code may be executed by processor 904 as it is received, and/or stored in storage device 910, or other non-volatile storage for later execution.

### VII. Alternate Embodiments

In an embodiment, a printing device comprises one or more processors and one or more memories communicatively coupled to the one or more processors, a code generation component, and a printing component. The code generation component is configured to generate a PHI code which comprises a human-readable component and a computer-readable component. The human-readable component indicates whether a document contains or is designed to contain PHI. The printing component is configured to print PHI codes on a printed medium. In an embodiment, the printing device also comprises a communication component, configured to send a message to a PHI tracking server that indicates that a PHI code has been generated.

In an embodiment, the printing component is also configured to print or attach RFID tags to the printed documents that contain the PHI codes. The printing device may also contain a tracking component, used to track the RFID codes. In addition, the printing device may comprise an alert component which creates an alert when the RFID tags leave a specified area.

In an embodiment, the printing device also comprises a code reader, capable of scanning the computer-readable component of the PHI codes. The printing device may also comprise a display component for displaying information associated with the PHI codes. The display component can be configured to display the information in response to the generation of a PHI code, the scanning of the PHI code by the code reader, or the receipt of a request to display the information.

In an embodiment, the printing device also comprises a document scanner capable of scanning documents that contain PHI, saving the scanned documents, and inserting PHI code metadata into the document. In another embodiment, the printing device also comprises an input component, allowing a user to input information to be associated with the PHI codes. An input component may also be configured to receive input specifying whether a document contains or is designed to contain PHI. In an embodiment, the printing device may also comprise a detection component which may determine whether a document contains PHI.

In an embodiment, an apparatus comprises one or more processors, one or more memories communicatively coupled to the one or more processors, a PHI code generator, and a PHI database manager. The PHI code generator may be configured to insert metadata into digital healthcare records that indicate whether the digital healthcare records contain PHI. The database manager may be configured to track the digital healthcare records by receiving an indication that an action has been performed on the digital healthcare record and storing information indicating at least that the action was performed on the digital healthcare record.

The PHI code generator may also be configured to determine whether the digital healthcare records contain PHI. If a record is determined to not contain PHI, the code generator may refrain from inserting the PHI metadata. The code generator may have multiple ways of determining if a record contains PHI. In the case of videos and audio recordings, the code generator may search through the recordings for an indication that they contain PHI. In the case of healthcare forms, the code generator may search for specific words or phrases that indicate the existence of PHI.

In another embodiment, the digital healthcare forms may contain fields that are marked as being designed to contain PHI. The PHI code generator may determine that the form contains PHI by determining that data has been entered into the marked fields. In an embodiment, some types of healthcare forms may be listed in a separate database as being designed to contain PHI. The PHI code generator may determine that a specific form is designed to contain PHI by searching for a listing of the form in the separate database.

In an embodiment, the actions tracked by the database manager include one or more of the following: printing the digital healthcare records, transmitting the digital healthcare records, deleting the digital healthcare records, or displaying the digital healthcare records. In the case of displaying the digital healthcare record, the database manager may be configured to determine that the digital healthcare record has been displayed longer than a specified period of time. In response, the database manager may send an alert to displaying device, send an alert to a system administrator, force the displaying device to close the digital healthcare record, alter the display of the displaying device, or any combination of the previously listed responses. In an embodiment, an apparatus comprises one or more processors, one or more memories communicatively coupled to the one or more processors, and a form generator configured to determine whether a healthcare related document contains or is designed to contain PHI, create a PHI code with a computer-readable portion and a human-readable portion that indicates whether the healthcare related document contains or is designed to contain PHI, display the PHI code in the healthcare related document, and update a database to indicate that a healthcare related document containing or designed to contain PHI has been created.

In an embodiment, the form generator is configured to print the healthcare related document with the PHI code. In another embodiment, the form generator is configured to store the healthcare related document along with metadata relating to the PHI code. In an embodiment the form generator determines that a healthcare related document contains PHI by accessing a database which specifies healthcare related documents that are designed to contain PHI and determining that the healthcare related document is specified in the database. The form generator may also be configured to mark portions of the healthcare related document that contain or are designed to contain PHI.

In an embodiment, the form generator may be configured to generate additional descriptive text along with the healthcare related document. In another embodiment, the form generator may receive an indication that a healthcare related document that contains or is designed to contain PHI has been associated with healthcare related documents that do not contain PHI. The form generator may respond by displaying a warning that a document that does not contain PHI is being associated with a document that does contain or is designed to contain PHI. Alternatively, the form generator may print the warning on one or more of the documents.

In another embodiment, an apparatus comprises one or more processors, one or more memories communicatively coupled to the one or more processors, and a PHI tracking server configured to store PHI codes pertaining to one or more healthcare related documents in a PHI database, receive an indication that an action has been performed with regards to the particular healthcare related document, and update the PHI database to indicate a change in status of the healthcare related document.

The actions tracked by the PHI server may include the creation of a healthcare related document with a PHI code, the assignment of a PHI code to an existing healthcare related document, the transfer of a healthcare related document to a different party, the filing of a healthcare related document, the destruction of a healthcare related document, the deletion of a healthcare related document, the access of a healthcare related document, or the receipt of a healthcare related document. The PHI database may relate the PHI codes to document types, creators of the healthcare related document, purpose or proposed use of the healthcare related document, iteration number which indicates how many prior versions exist of the healthcare related document, and a date and time of creation of the particular healthcare related document.

The status information stored in the PHI database may include indications that a particular healthcare related document has been filed, transferred to another party, or destroyed. Additionally, status information may include indications that the healthcare related document is currently in use or that the healthcare related document is missing. The PHI tracking server may receive additional indications that actions have been performed with respect to the healthcare related documents. The PHI server may then update the PHI database to indicate the change in status and store the past status information.

The PHI tracking server may also respond to requests for information regarding one or more of the PHI codes. The PHI server would access the PHI database to obtain the requested information. An implementation may include a graphical user interface which is configured to display status information and receive input that changes the status information

An implementation may also include a computer-implemented method for improving a healthcare system which comprises generating PHI codes for one or more healthcare documents, updating a PHI database with information relating to the PHI codes, tracking the documents that contain the PHI codes, and generating reports regarding the documents that contain the PHI codes. The healthcare system may identify whether a healthcare related document contains or is designed to contain PHI by accessing a database which specifies healthcare related documents that contain or are designed to contain PHI and determining that the healthcare related document is specified in the database.

The information relating to the PHI codes may include a document type, a creator of the document, a proposed use of the document, an iteration number which indicates how many prior versions of the document exist, and a current location of the document. Tracking the document may comprise receiving user input specifying changes to the information and updating the PHI database to include the changes to the information. Tracking the document may also comprise reading the computer-readable component of the code, receiving an indication that an action has been performed or soon will be performed, and updating the PHI database to include changes to the information caused by the action.

In an embodiment, the computer implemented method may also include determining that a document exists, but that no actions have been recorded with regards to the document. In response, an alert may be generated that indicates that the document is missing.

In an embodiment, the information in the reports may include the status and location of the documents. The reports may also indicate a level of compliance with current healthcare regulations. Additionally, the reports may include any of the number of documents filed, under review, deleted, unaccounted for, and transferred to another party or facility. Additionally, in the case that documents have been transferred to another party or facility, the information in the reports may include a chain of custody for the healthcare related documents.

In the foregoing specification, embodiments have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. An imaging device comprising:
one or more processors and one or more memories communicatively coupled to the one or more processors;
a Protected Health Information (PHI) code detection component configured to detect a computer-readable portion of PHI codes on one or more documents;
wherein the PHI codes comprise a computer-readable portion and a human-readable portion;
wherein the human-readable portion visually indicates to a user whether a printed document contains or is designed to contain PHI; and
a communication component configured to send a message to a PHI tracking server that indicates that the one or more events have occurred with respect to a document containing a PHI code.

2. The imaging device of claim 1 wherein the one or more events include one or more of:
a document with a PHI code being created;
a document with a PHI code being destroyed;
a document with a PHI code being detected;
a document with a PHI code being replaced;
a document with a PHI code being copied; or a document with a PHI code being displayed.

3. The imaging device of claim 1 further comprising:
a code generation component configured to generate PHI codes; and
a printing component configured to print the computer-readable portion and the human-readable portion of the PHI codes on a printed medium.

4. The imaging device of claim 3 wherein the printing component is further configured to print or attach one or more RFID tags to one or more printed documents that contain a PHI code.

5. The imaging device of claim 4 further comprising:
a tracking component configured to track the one or more RFID tags; and
an alert component configured to create an alert when the one or more RFID tags leave a specified area.

6. The imaging device of claim 1 further comprising:
a display component configured to display information associated with one or more PHI codes in response to one or more of:
receiving an indication that the code reading component has detected a computer-readable portion of a PHI code; or
receiving an indication that the code detecting component has detected both a PHI code and a non-PHI code which indicates that a document does not contain PHI on one or more documents.

7. The imaging device of claim 1 further comprising a scanning component configured to:
scan one or more printed documents that contain PHI;
save the one or more healthcare related documents as one or more digital documents; and
insert metadata that is associated with a PHI code into the one or more digital documents.

8. The imaging device of claim 1 further comprising an input component configured to accept input specifying information to be associated with one or more PHI codes.

9. The imaging device of claim 1 further comprising an input component configured to accept input specifying that a printed document contains or is designed to contain PHI.

10. The imaging device of claim 1 further comprising a PHI detection component configured to determine whether a printed document contains PHI.

11. One or more computer-readable media storing instruction which, when processed by one or more processors cause:
a code detector on an imaging device to detect a computer-readable portion of one or more Protected Health Information (PHI) codes;
wherein the PHI codes comprise a computer-readable portion and a human-readable portion;
wherein the human-readable portion visually indicates to a user whether a printed document contains or is designed to contain PHI; and
a communicator on the imaging device to send a message to a PHI tracking server that indicates that the one or more events have occurred with respect to a document containing a PHI code.

12. The one or more computer-readable media of claim 11, further comprising additional instructions which, when processed by the one or more processors, cause:
a code generator on an imaging device to generate PHI codes; and
a printer on the imaging device to print PHI codes on a printed medium.

13. The one or more computer-readable media of claim 12, further comprising additional instructions which, when processed by the one or more processors, cause the printer to print or attach one or more RFID tags to one or more printed documents that contain a PHI code.

14. The one or more computer-readable media of claim 13, further comprising additional instructions which, when processed by the one or more processors, cause a tracker on the imaging device to track the one or more RFID tags and create an alert when the one or more RFID tags leave a specified area.

15. The one or more computer-readable media of claim 11, further comprising additional instructions which, when processed by the one or more processors, cause one or more computing devices to display information associated with one or more PHI codes in response to one or more of:
receiving an indication that the code reading component has detected a computer-readable portion of a PHI code; or
receiving an indication that the code detecting component has detected both a PHI code and a non-PHI code which indicates that a document does not contain PHI on one or more documents.

16. The one or more computer-readable media of claim 11, further comprising additional instructions which, when processed by the one or more processors, cause a scanner on the imaging device to:
scan one or more printed documents that contain PHI;
save the one or more healthcare related documents as one or more digital documents;
generate a digital PHI code; and
insert the digital PHI code into the one or more digital documents.

17. The one or more computer-readable media of claim 11, further comprising additional instructions which, when processed by the one or more processors, cause a computing device to accept input that specifies one or more of:
information to be associated with one or more PHI codes; or
that a printed document contains PHI.

18. A computer-implemented method comprising:
detecting a computer-readable portion of one or more Protected Health Information (PHI) codes;
wherein the PHI codes comprise a computer-readable portion and a human-readable portion;
wherein the human-readable portion visually indicates to a user whether a printed document contains or is designed to contain PHI; and
determining that one or more events have occurred with respect to a document containing a PHI code; and
sending a message to a PHI tracking server that indicates that the one or more events have occurred.

19. The computer-implemented method of claim 18 further comprising:
generating one or more PHI codes; and
printing the one or more PHI codes on one or more printed documents;
attaching one or more RFID tags to the one or more printed documents that contain;
tracking the one or more RFID tags; and
creating an alert when the one or more RFID tags leave a specified area.

20. The computer-implemented method of claim 18 further comprising:
scanning one or more printed documents that contain PHI;
saving the one or more healthcare related documents as one or more digital documents;
generating a digital PHI code; and
inserting the digital PHI code into the one or more digital documents.
